(19) United States
(12) Patent Application Publication
(10) Pub. No.: US 2006/0050607 A1
(43) Pub. Date: Mar. 9, 2006

(54) Mixing head for a reaction injection molding machine

(75) Inventors: Stefan Ehrlicher, München (DE); Robert Brunner, Augsburg (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, München (DE)

(21) Appl. No.: 11/235,526

(22) Filed: Sep. 26, 2005

Related U.S. Application Data
(63) Continuation of application No. PCT/EP04/02003, filed on Feb. 28, 2004.

(30) Foreign Application Priority Data
Mar. 28, 2003 (DE) 103 14 117.0

(51) Int. Cl. B29B 7/76

(52) U.S. Cl. 366/162.4

(57) ABSTRACT

A mixing head for a reaction injection molding machine includes a body including a mixing chamber formed with an injection bore. In addition to a charging assembly for introducing at least two reactive components into the mixing chamber, there is provided a feed assembly having at least two feeds for supply of different additional components to the mixing chamber. A moveable adapter selectively and detachably couples the feeds of the feed assembly to the injection bore for selective introduction of the additional components. The adapter is constructed for rotation in relation to the mixing chamber so that an exit port of each feed is connectable with the injection bore through rotation of the adapter.

### CROSS-REFERENCES TO RELATED APPLICATIONS

This application is a continuation of prior filed copending PCT International application No. PCT/EP2004/002003, filed Feb. 28, 2004, which designated the United States and on which priority is claimed under 35 U.S.C. §120 and which claims the priority of German Patent Application, Serial No. 103 14 117.0, filed Mar. 28, 2003, pursuant to 35 U.S.C. 119(a)-(d), the subject matter of which is/are incorporated herein by reference.

### BACKGROUND OF THE INVENTION

The present invention relates, in general, to a mixing head of a reaction injection molding machine.

Various types of mixing heads for reaction injection molding machines, in particular polyurethane foam molding plants, are known from the prior art for mixing with one another at least two reactive components, in the case of polyurethane at least polyol and polyisocyanate, and subsequent reaction.

Deflection mixing heads are known in which a mixing chamber is arranged at a right angle to an outlet tube for the finished mixture. Mounted in the mixing chamber for travel is a movable control piston, and the reactive components are introduced by charging devices into the mixing chamber at same level under high pressure. The components mix, whereby the jet direction in particular of the supplied components is also relevant for the mixture since the generated turbulence is able to realize an intimate thorough mixing. Typically, the components are therefore injected substantially toward one another. The finished mixture is discharged by the control piston from the mixing chamber via an adjustable choke into the outlet tube disposed perpendicular to the mixing chamber so as to reduce the turbulence of the mixture. In general, the control piston moveably arranged in the mixing chamber is so constructed as to have circulatory grooves to ensure that the charging devices for the reactive components are under constant pressure, and that in a so-called rest phase, i.e. in the absence of a mixing of components, each component is able to circulate via a circulatory groove back into the respective reservoir for the corresponding component. This has the advantage that there is no need to adjust the charging device itself, which introduces for example the component via a nozzle into the mixing chamber but rather the nozzle can be covered in the rest phase by the circulatory groove so as to be able to assure a stationary mode of operation.

A further known construction of a mixing head is the so-called circulatory groove type mixing head in conjunction with calming pins. The mixing chamber has here a longitudinal axis which is identical to the discharge direction, and several calming pins are arranged at the outlet of the mixing chamber to ensure that the outgoing reaction mixture is free of a too uneven flow distribution. Also in this case, the reactive components are injected into the mixing chamber during the mixing process under high pressure and circulated back to the respective reservoir during a rest phase via circulatory grooves in a control piston.

Various types of mixing heads are described, for example in “Kunststoffmaschinenführer” [guide to plastics machines], publisher Dr.-Ing. Friedrich Johannaber, 3^{rd} edition, Carl Hanser Verlag.

In the event, additional components should be admixed to the reactive mixture, in particular various dyes of additives such as flame retardants, activators and catalysts, problems arose to some extent in connection with the supply of the additional components. German Pat. No. DE 41 24 599 proposes the introduction of the additional component into the mixing chamber simultaneously with the reactive components. Such an introduction may also be realized via controllable valves, for example needle valves. Typically, the feed device for the additional component is provided in the wall of the mixing chamber at the same level as the charging devices for the reactive components. Such a construction is disclosed in German Pat. No. DE 41 40 787 C1 in which the control of the valves from feed devices to feed devices is realized via a control disk which is arranged for rotation about the axis of the mixing chamber so as to enable a precise synchronization of the supply of the individual components. The burden to change the composition of the respectively introduced components is however great in such a construction.

It is also known, to mount the feed device in relation to the discharge direction before the charging devices for the reactive components so as to ensure in any event a very thorough mixture of the additional components. According to an alternative variant, the dye may be supplied into the mixing chamber via an end surface of the control piston. However, the size of the mixing chamber restricts in any event the number of possibly additional components that can be supplied.

It would therefore be desirable and advantageous to provide an improved mixing head for reaction injection molding, to obviate prior art shortcomings and allow regardless of size of the mixing chamber to process several automatically selectable additional components, while yet experiencing at most negligible carry-over of remnants of a preceding processed additional component.

### SUMMARY OF THE INVENTION

According to one aspect of the present invention, a mixing head for a reaction injection molding machine includes a body having a mixing chamber formed with an injection bore, a charging assembly for introducing at least two reactive components into the mixing chamber; a feed assembly having at least two feeds for supply of different additional components to the mixing chamber, and a moveable adapter for selectively and detachably coupling the feeds of the feed assembly to the injection bore for selective introduction of the additional components, wherein the adapter is constructed for rotation in relation to the mixing chamber so that an exit port of each feed is connectable with the injection bore through rotation of the adapter.

During operation of such a mixing head, the at least two reactive components, which preferably are under high pressure, and the additional component are introduced at the same time into the mixing chamber to blend to a homogenous mixture. To optimize the mixture of the components, various mixing head geometries are known in the prior art. Advantageous in the present invention is however a selective changeability of the additional component from mixing head charge to mixing head charge. A mixing head according to the invention is thus more flexible than conventional mixing heads as the dye for example may vary from shot to shot, a fact that is of great interest e.g. for the production of varied like parts of different color directly in succession or of large-area internal automobile parts with various layers.

The at least two feeds of the feed assembly for the additional components may hereby integrated in the moveable adapter which alternatingly connects them with the injection bore. By turning the adapter, a selected exit port of a feed is brought in registration with the injection bore.

Advantageously, the mixing chamber of a mixing head according to the invention may be configured such that the charging assembly for the reactive components and the injection bore extend essentially in the same plane perpendicular to the discharge direction of the mixing chamber. This ensures an optimum mixture of the reactive components with the additional components. This is the case in particular when the reactive components are under high pressure and injected into the mixing chamber essentially towards one another so as to mix well with one another as a consequence of the resultant formation of turbulence but also mix with the introduced additional component at the same level of the mixing chamber. The additional component need not be under the same high pressure as the reactive components. The discharge direction in which the injection bore and the charging assembly for the reactive components lie at the same level in the mixing chamber is predefined preferably by the movement direction of a control piston which is movable in the mixing chamber and also provided to realize an expulsion of the mixture form the mixing chamber.

According to another feature of the present invention, the feed assembly for the additional components may include at their exit ports nozzle devices for realizing a precise metering of the additional components into the mixing chamber via the injection bore. The feeds for the additional components are connected to reservoirs which store these additional components, optionally maintain them at moderate temperature and circulate them, to provide an optimal processing state.

According to another feature of the present invention, may be provided a vacuum apparatus may be provided which can be connected to the moveable adapter for cleaning the injection bore. This vacuum apparatus can be connected to the injection bore between two shots to which different additional components have been admixed, so that possible residues of the previously discharged additional component are removed from the injection bore. This ensures that the quality of the mixture during the subsequent shot, using another additional component, is not impaired.

The moveable adapter may have a substantial piston-shaped configuration or may have at least one piston-shaped forward zone. The term “forward zone” relates hereby to an area of the moveable adapter substantially adjacent to the mixing chamber or the injection bore. For sake of simplicity, the following description refers only to “piston-shaped forward zone”.

According to another feature of the present invention, the piston-shaped forward zone is defined by a longitudinal axis which may be oriented in a plane perpendicular to the discharge direction of the mixing chamber.

According to another feature of the present invention, the longitudinal axis of the piston-shaped forward zone may extend parallel but not coaxial to a center axis of the injection bore. The exit ports of the feeds for the additional components are provided in this case in an end surface of the piston-shaped forward zone. The end surface overlaps the injection bore, and the exit ports can be brought in registration by turning the moveable adapter and thus also the piston-shaped forward zone in relation to the injection bore.

According to another feature of the present invention, the feeds of the feed assembly for the additional components may include axis-parallel feed bores in the piston-shaped forward zone whereas connections to the reservoirs for the additional components may be provided at one of the exit ports and thus at an adapter side distal to the end surface. These connections may extend at an angle to the axis of the piston-shaped forward zone and supplied for example via flexible hoses. The adapter may hereby be configured substantially in a manner of a rotary switch, whereby the rotating motion enables a switching between the feeds for different additional components. The number of additional components that can be supplied in this way is only limited by the size of the end surface of the moveable adapter.

According to another feature of the present invention, the piston-shaped forward zone of the adapter may be constructed to travel substantially tangential to the mixing chamber and/or configured rotatably, wherein the injection bore forms essentially the contact point of the tangent. Exit ports of the feeds are hereby arranged in a plane perpendicular to the axis of the piston-shaped forward zone and oriented substantially radial. They are supplied from axis-parallel feed bores which are provided in the piston-shaped forward zone and which again are preferably supplied from connections provided in the region of the outer surface area of the piston-shaped forward zone. These connections are connectable with reservoirs for the additional components through axial movement of the piston-shaped forward zone and are axially offset relative to one another. The individual connection zones are preferably sealed from one another to prevent carry-over of additional components such as, for example, dye residues. Involved here are advantageously grooves which are lined with sealing compound which is applied about the piston-shaped forward zone on the outside or axially offset to the respective connections.

In a moveable adapter configured in this manner for the additional components, the piston-shaped forward zone may be positioned through rotary movements such that the exit port for the desired additional component is brought in registration with the injection bore, whereby a pure rotary movement is sufficient for the change between different additional components. It is then only necessary to establish a connection in the respective position of the moveable adapter from one reservoir to the respective connection for the axis-parallel feed bore. This may be realized, for example, by ring-shaped connection devices provided in the piston space and positioned axially offset relative to one another in correspondence to the axial offset of the connections of the feeds of the feed assembly. This ensures the provision of a connection between the reservoir for the additional component and the exit port which is in registration with the injection bore.

When the reactive components are injected into the mixing chamber, a bypass provided in the region of the reservoir can be closed so that the additional component enters the mixing chamber at the same time as the other components. At the conclusion of the shot, this bypass opens again.

As an alternative, the piston-shaped forward zone may have traveled relative to the injection bore in axial direction to such an extent that the exit bore for the desired additional component and the injection bore are not yet in registration while a connection between feed and reservoir already exits and is set under pressure, i.e. the bypass is closed. At or shortly before the point in time when also the reactive components are injected into the mixing chamber, the piston-shaped forward zone is moved such that the exit port for the additional component is in registration with the injection bore so as to allow also its introduction into the mixing chamber.

According to another feature of the present invention, at least one bore may be provided at a distance to the exit ports for the additional components in the piston-shaped forward zone and can be brought into communication with the injection bore and with a vacuum apparatus so that the injection bore can be purged between changes of the additional components from possible residues of the preceding component through application of a vacuum. The at least one bore may situated at an axial distance to the exit ports, although it is, of course, also conceivable to provide them in regions between the exit ports.

In general, it is of advantage to allow heating of the moveable adapter independently of its particular construction because in this way the viscosity of the additional components can be positively influenced.

It is also advantageous to so construct the moveable adapter as to be pressable against the injection bore. In this case, the moveable adapter can be pressed against the injection bore during introduction of an additional component into the mixing chamber so as to eliminate a risk of possible leakage of the additional component in areas about the injection bore. A high pressure may be exerted also during a cleaning step by applying a vacuum in the injection bore in order to seal the injection bore. When executing a change between additional components through movement of the adapter in relation to the injection bore, the pressure between the adapter and the injection bore is reduced. The contact pressure is preferably applied by hydraulic or electromagnetic means.

Electric or hydraulic means may be provided for moving the moveable adapter in relation to the mixing chamber.

The additional components for admixture to the reactive components oftentimes involve different dyes. In the absence of any need for substantial modification, a single mixing head can now be used to produce plastic material of various colors, a fact that can be of advantage during production of a multi-colored or multi-layered part of various colors or also during successive production of like parts of different colors. There is however a number of further additional components, such as, for example, flame retardants or activators and catalysts for the reactive components.

It is especially preferred to provide the reservoirs for the additional components with a circulation system having a bypass circuit so that the additional components can be introduced either into the feeds or bypass them. This is of interest also in conjunction with using dyes as additional components because in this way an even quality and homogeneity of the colors is ensured. When the bypass circuit is closed, the additional component is under pressure in the feed assembly, whereas the additional component circulates in a closed loop, when the bypass is open.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal section of one embodiment of a mixing head according to the present invention;

FIG. 2 is a partly sectional view of one embodiment of an adapter constructed in the form of a carriage for application in a mixing head according to the present invention;

FIG. 3 is a section of the adapter, taken along the line III-III in FIG. 2;

FIG. 4 is a sectional view of one embodiment of an exit port of a feed of a feed assembly;

FIG. 5 is a sectional view of another embodiment of a moveable adapter for application in a mixing head according to the present invention;

FIG. 6 is a sectional view of a mixing head according to the present invention, having incorporated the adapter of FIG. 5;

FIG. 7 is a sectional of still another embodiment of a moveable adapter for application in a mixing head according to the present invention;

FIG. 8 is a sectional view of the adapter of FIG. 7, taken along the line VIII-VIII in FIG. 7, and

FIG. 9 is a developed view of the moveable adapter in the form of the feed piston of FIG. 7.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

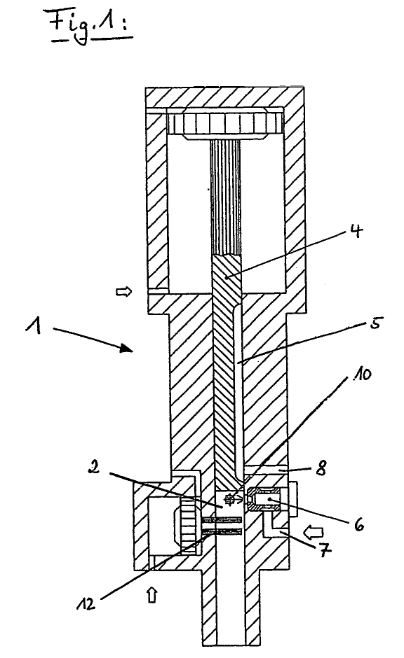

Turning now to the drawing, and in particular to FIG. 1, there is shown a longitudinal section of one embodiment of a circulatory groove type mixing head 1 with calming pins 12 as an example of an embodiment of a mixing head for which the present invention is applicable. The mixing head 1 comprises a body which includes a mixing chamber 2 which supports a control piston 4 for axial movement. Terminating in the mixing chamber 2 are charging devices 6 of which only one is depicted, for supply of reactive components, like polyisocyanate and polyol, which respectively are supplied via an inlet 7. The charging devices 6 are preferably situated at the same level in relation to an outlet or discharge direction of the mixing chamber, as predefined by the movement of the control piston which movement extends downwards in FIG. 1. Also situated at the same level is an injection bore 10 via which additional components can be introduced into the mixing chamber 2. At idle run or closed state, the control piston 4 moves to a downward position so that each charging device 6 for reactive components is overlapped respectively by a circulatory groove 5 and the reactive components are respectively free to circulate between the inlet 7 and an outlet 8 which leads back into a storage reservoir for the respective component. Only when the mixing chamber 2 should be filled is the control piston 4 moved upwards, thereby opening the charging device 6 in relation to the mixing chamber 2, and an injection process is executed in the mixing chamber 2 with mixing of the components there. As the reactive components are under pressure and injected in the mixing chamber 2 preferably essentially toward one another, a thorough mixing of the components is ensured. Disposed at the mixing chamber outlet are several calming pins 12 in 90° offset relationship to the outlet direction which are controlled by a logic and pushed into the outlet system immediately after clearance by the control piston 4. They provide a desired restriction of the mixing chamber and calm the outgoing reaction mixture. As a consequence of the injection bore 6 provided in addition to the charging devices 6, an additional component can be introduced into the mixing chamber 2 simultaneously with the reactive components. This additional component does not require the presence of a circulatory groove in the control piston 4 so that a carry-over of the additional component is substantially eliminated.

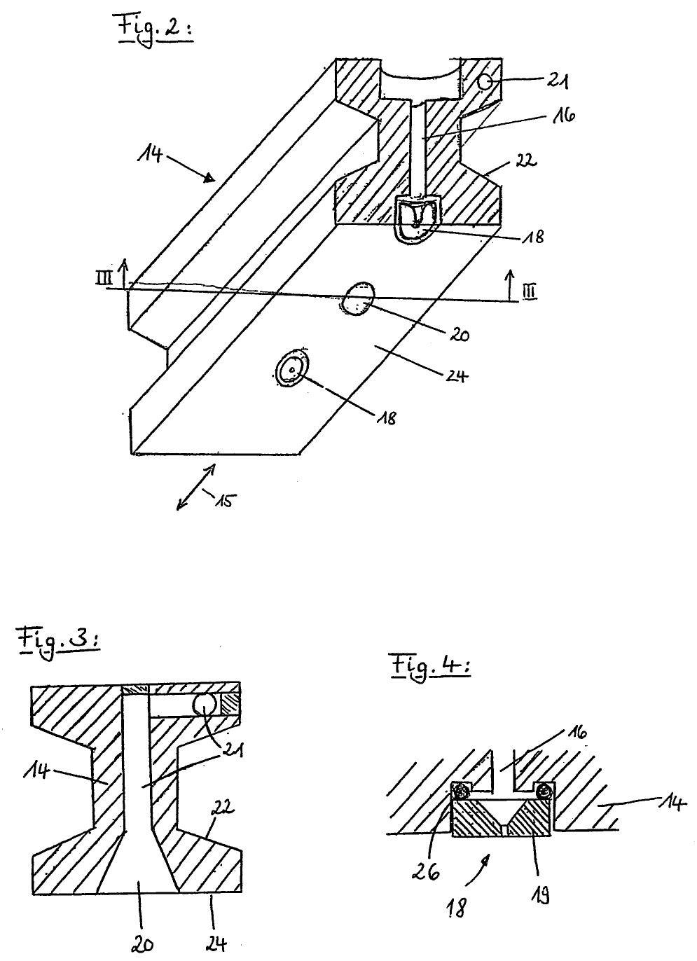

FIG. 2 shows one embodiment of a moveable adapter in the form of a carriage 14 to supply different additional components to an injection bore 10. The carriage 14 is mounted to the mixing chamber 2 according to FIG. 1 so as to be moveable tangentially to the mixing chamber 2 in order to be able to bring feeds 16 of a feed assembly, shown by section in FIG. 2, in registration with the injection bore 10 via nozzle devices 18, provided at their exit ports. The carriage 14 has hereby in the area of the nozzle devices 18 a sliding surface 24 which permits a displacement of the carriage 14 along a direction, as indicated by the arrow 15, in a manner that is as free of resistance as possible. Further provided are contact surfaces 22 which can be subjected to pressure, when an additional component is introduced via a feed 16 through the injection bore 10 into the mixing chamber 2 to thereby ensure a tightest possible connection between carriage 14 and injection bore 10, i.e. the surface of the mixing head 1 interacting with the sliding surface 24. Disposed between two nozzle devices 18 is an exit port 20 of a vacuum channel 21 which exit port 20 can be brought in registration with the injection bore 10 between two different charging operations of different additional components. The vacuum channel 21 then establishes a connection with a vacuum apparatus, not shown in greater detail, so that potentially remaining residues in the injection bore 10 of the preceding additional component are sucked off. During this purging step, the control piston 4 assumes its closing or circulatory position, i.e. it covers the injection bore 10 and the charging devices 6, and the reactive components are able to circulate via the circulatory grooves 5.

FIG. 3 shows a section through the carriage 14 of FIG. 2 along the section line III-III. The exit port 20 of the vacuum channel 21 has a diameter which substantially corresponds to the diameter of the injection bore 10, and the vacuum channel 21 passes by the feeds 16 along the entire carriage 14 so as to be able to supply also several exit ports which are provided between various nozzle devices 18 of the feeds 16 of the feed assembly. Suitably, the carriage 14 has an exit port 20 of the vacuum channel 21 between each pair of feeds 16 so as to facilitate the purging step.

The length of the carriage 14 is limited only by the size of the mixing head 1 and defined otherwise by the number of additional components to be supplied alternatingly.

The precise manner of the connection of the feeds 16 to a reservoir for the additional component is not shown in greater detail; however many types of connections between elements that move relative to one another are known in the prior art.

FIG. 4 shows an embodiment of a nozzle device 18, with a sealing device 26, for example in the form of an O ring, being provided in a groove at the exit port of the feed 16, and a nozzle plate 19 being arranged anteriorly thereto and suited to the properties of the respectively supplied additional component as far as shape and diameter are concerned. The use of this nozzle plate 19 in cooperation with the sealing device 26 is able to produce a better forced engagement of the nozzle device 18 upon the injection bore 10 with improved sealing action as a consequence of the application of a slight pressure.

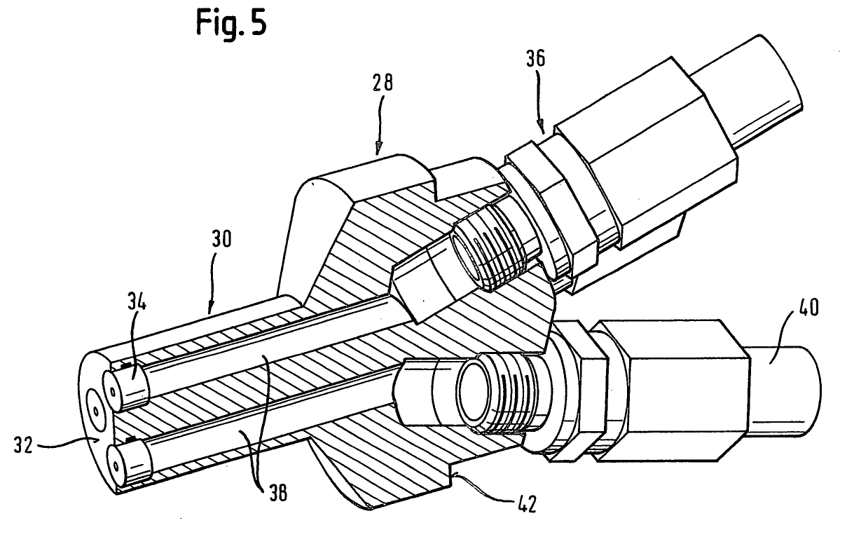

FIG. 5 depicts a moveable adapter according to the present invention, generally designated by reference numeral 28. Involved here is a type of rotary switch, i.e. the moveable adapter 28, which has a forward zone 30 constructed in the shape of a piston so as to define a rotation symmetry in relation to a longitudinal axis. This piston-shaped forward zone 30 has an end surface 32 in which exit ports 34 of a feed assembly, generally designated by reference numeral 36, terminate. These exit ports 34 may be shaped in the form of a nozzle device, as shown by way of example in FIG. 4. The feed assembly 36 is provided in the piston-shaped forward zone 30 with axis-parallel feeds 38 in the form of bores 38 which are connected at their rear end with reservoirs for the additional components via connections 40. These connections 40 are not shown in greater detail and may be realized for example via flexible hose connections. Further provided in the area of transition of the feed bores 38 to the connections 40 is a contact surface 42 which can be subjected to a pressure for urging the exit ports 34 in the end surface 32 of the piston-shaped forward zone 30 against the injection bore 10 to realize a tight connection.

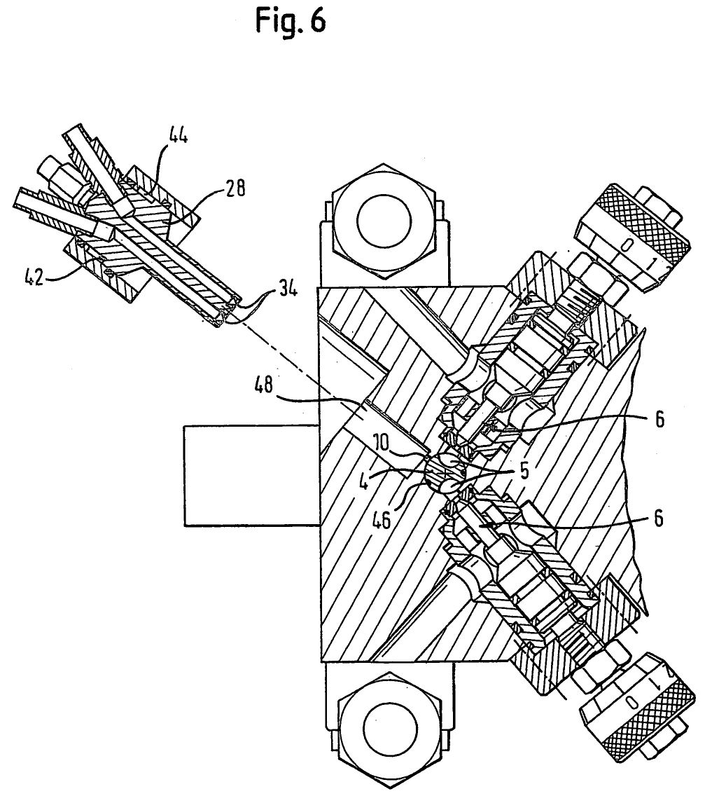

FIG. 6 shows a section through a mixing head 1 according to the invention perpendicular to the discharge direction of the mixing chamber 2, using the moveable adapter 28 according to FIG. 5. Schematically shown are two charging devices 6 which terminate in the mixing chamber 2 in a plane and essentially in confronting orientation, with the control piston 4 in the mixing chamber 2 assuming the circulation position, i.e. the exit ports of the charging devices 6 are connected via the circulatory grooves 5 with reservoirs, not shown in greater detail, for the additional components. In general, the mode of operation of such charging devices 6 is known in the art. Ending at the injection bore 10, which is situated in the same plane as the exit ports of the charging devices 6, is a precision bore 48 which has a longitudinal axis extending parallel but not coaxial to the longitudinal axis of the injection bore 10, and which receives the moveable adapter 28 with precision fit. By turning the adapter 28 about the longitudinal axis of the precision bore 48, the exit ports 34 of the feed assembly 36 integrated in the moveable adapter 28 can alternatingly be brought into registration with the injection bore 10 so that the respective additional component can be injected simultaneously with the reactive components from the charging devices 6 into the mixing chamber 2, when the control piston 4 is retracted. During such an injection step, the moveable adapter 28 can additionally be snugly sealed against the end surface of the precision bore 48 by the application of pressure in a pressure space 44 which acts on the contact surface 42 of the adapter 28. In order to ensure a particular tightness also between both circulatory grooves 5 in the control piston 4 and the respective additional component, these grooves 5 and the area of the injection bore 10 may be sealed from one another by additional seals 46.

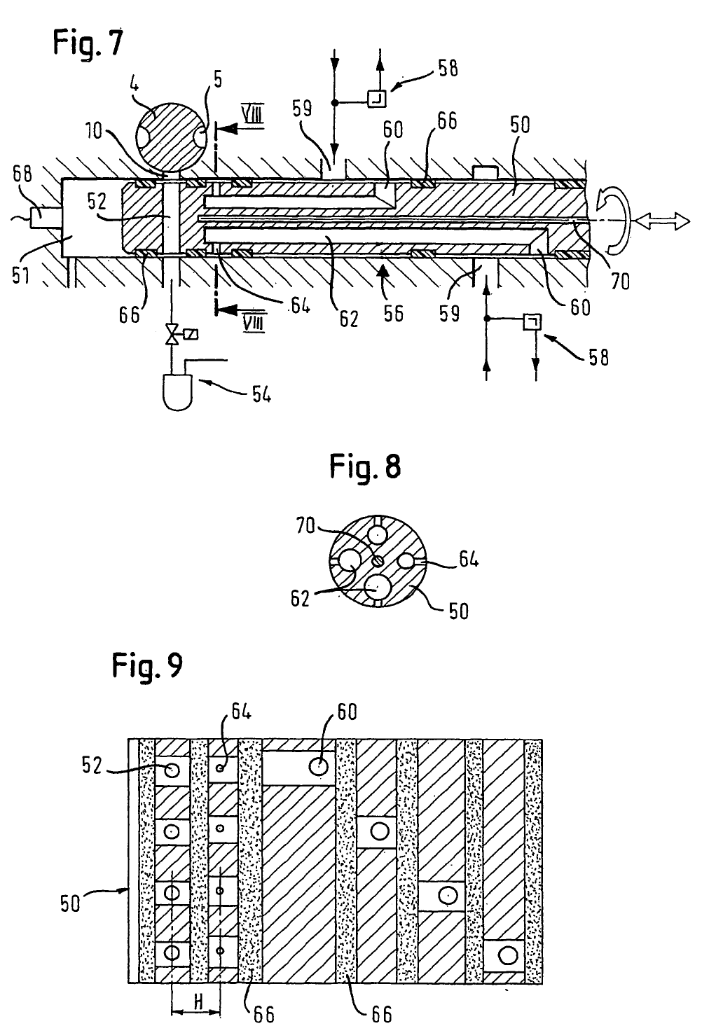

FIG. 7 illustrates a section of another embodiment of a moveable adapter in the form of a so-called feed piston 50 with feeds 56 and a schematically shown mixing chamber 2 with control piston 4. The control piston 4 in the mixing chamber 2 is in the circulation position. The feed piston 50 has a substantial piston-shaped configuration and is supported in a piston chamber 51 for axial and rotary motions, as indicated by the arrows on the right-hand side. A vacuum bore 52 extends through the feed piston 50 in registration with the injection bore 10 and in communication with a vacuum apparatus 54, shown only schematically here. A further vacuum bore may additionally be provided to extend precisely at a right angle to the vacuum bore 52. Disposed in a plane offset axially to the right of the vacuum bore 52, i.e. the section plane VIII-VIII, are atomizing bores 64 which extend substantially radial in the feed piston 50 and respectively communicate with axial feed bores 62 which in turn can be brought in registration with feed ports 59 via a radially directed inlet bore 60. A feed 56 essentially includes as exit port an atomizing bore 64, an axial feed bore 62 and an inlet bore 60. The feed ports 59 are arranged preferably in the wall of the piston chamber 51 and are arranged about the feed piston 50 preferably in the form of a ring and communicate with circulation systems 58, not shown in greater detail, for the respective additional components. Arranged between the vacuum bores 52, the atomizing bores 64 and the various inlet bores 60 that are axially offset to one another are seals 66 which are attached about the feed piston 50 for substantially preventing additional components from escaping outside the associated zones and thereby preventing a mixture of the additional components. The seals 66 may be realized as grooves lined with sealing compound, as described above in conjunction with the control piston 4 of mixing head 1. A heater cartridge 70 is further provided along the axis of the feed piston 50.

FIG. 8 shows a section through the feed piston 50 along the section line VIII-VII in FIG. 7. The feed piston 50 is here constructed for the alternating supply of four different additional components. The axial feed bores 62 for connecting the circulation systems 58 for the additional components with the atomizing bores 64 have different diameters which depend on the length of the respective axial feed bore 62 and the accompanying pressure loss encountered there as well as the properties of the additional component, such as its viscosity. The diameter of the atomizing bores 64 may also be suited to the components to be discharged. Furthermore, it is also possible to provide special nozzle devices instead of the simple atomizing bores 64.

FIG. 9 depicts a developed view of the feed piston 50 of FIG. 7. Clearly visible are the seals 66 which extend perpendicular to the longitudinal axis and seal the various zones of the feed piston 50 from one another. Two vacuum bores 52 extend at a right angle to one another through the axis of the piston 50. The atomizing bores 64 and the respectively associated inlet bores 60 have each in a small area about the bore a slight space between the surface of the feed piston 50 and the piston chamber 51, the feed piston 50 is ground here for example, while the areas that extend along the circumference between the individual bores and shown shaded, are preferably as precise as possible, i.e. snugly fitted against the wall of the piston chamber 51 or coated with sealing compound. FIG. 9 further shows in a very clear way the axial offset along the circumference of the individual inlet bores 60. The maximum stroke H during normal operation is defined by the axial distance between the center points of the vacuum bores 52 and the atomizing bores 64. By providing a respective width of the respective seals 66, it can be ensured that no or no direct carry-over of the additional components takes place between the individual feed areas.

At operation, as illustrated in FIG. 7, the vacuum bore 52 is brought in registration with the injection bore 10 and connected with a vacuum apparatus 54, when the control piston 4 assumes the circulation position, so that possible residues of an additional component or also of the reactive mixture from the injection bore 10 and discharged from the mixing chamber 2 during the preceding step can be sucked off to clean the injection bore 10.

In a next step, turning of the feed piston 50 so positions the atomizing bore 64 associated to the desired additional component as to have only an axial offset in relation to the injection bore 10. The feed piston 50 is now shifted to the left so that the atomizing bore 64 is positioned above the injection bore and at the same time establishes a connection between the inlet bore 60 and the respective circulation system 58 via the associated feed port 59. Controlled by a logic, the schematically illustrated bypass of the circulation system 58 is closed in relation to the opening of the control piston 4 of the mixing head 1 so that the additional component enters the mixing chamber 2 simultaneously with the reactive components, because closure of the bypass leads to a pressure buildup at the atomizing bore 64. In general, the pressure by which the additional component is introduced into mixing chamber 2 is below the pressure of the reactive components. The pressure for the reactive components ranges for example from 150-200 bar, whereas the additional components are introduced predominantly at a pressure in the range of 80-150 bar. The high-pressure introduction of the reactive components causes, however, such turbulences in the mixing chamber 2 that the components introduced at lesser pressure are thoroughly mixed.

In a following step, the control piston 4, controlled by timer, closes and the bypass opens again so that the additional component again is able to circulate freely in the circulation system 58. The feed piston 50 travels again to the right so that the injection bore 10 and a vacuum bore 52 are brought in registration, and the injection bore 10 can be purged by applying a vacuum.

The next mixing step is executed in like manner, whereby another additional component can be transferred to the injection position at the injection bore 10. In the event, successive mixing operations involve a supply of the same component, the need for a cleaning step may be omitted. The atomizing bore 64 then stays in position behind the injection bore 10, and the bypass only is closed at the same time as the control piston 4 is closed. As an alternative to this bypass solution, it is, of course, also possible to open and close the feed port 59 by a closeable valve.

According to an alternative mode of operation, a first step, as described above, involves a cleaning of the injection bore 10 of the feed piston 50 by vacuum, subsequently the atomizing bore 64 of the desired additional component is transferred into the correct circumferential position by turning the feed piston 50, although an axial offset in relation to the injection bore 10 still exists, and the bypass of the associated circulation system 58 is closed. As a result, pressure builds up already at the feed port 59.

In the next step, the feed piston 50 is so controlled as to move shortly before or at the same time as the control piston 4 opens to the forward position in which the atomizing bore 64 is in registration with the injection bore 10. As soon as the control piston 4 of the mixing head opens, the additional component is able to enter the mixing chamber 2 under pressure. Following the end of the shot, the control piston 4 closes and the feed piston 50 retracts, the bypass of the circulation system opens and the injection bore 10 is purged by vacuum.

The exact position of the feed piston 50 may be additionally determined by provided position transmitters 68.

Also in the embodiment of an adapter constructed as feed piston 50, the number of possible additional components is only limited by the size and diameter of the feed piston 50 and by the overall size of the mixing head 1 which has to accommodate the feed piston 50.

Control of the adapters 14, 28 of a mixing head according to the invention is implemented in like manner as described here with reference to a feed piston 50.

The advantage of a mixing head according to the invention resides in the fact that regardless of the actual size of the mixing chamber any number of additional components can be admixed to the reactive mixture and a change between the various additional components can be carried out automatically from shot to shot. Only a minimal carry-over of the respective additional component is experienced. In addition, cleaning measures may be provided with the aid of a vacuum apparatus. Such a configuration of the mixing head results in a far more flexible reaction injection molding because reactive mixtures with different properties can be discharged, for example with different colors, in immediate succession by using a single mixing head. This is especially of advantage when larger parts, such as molded skins for internal automobile parts, should be produced from various components in one working step.

The problem encountered in conventional mixing heads and relating to the limitation of the possible number of additional components because of the size of the mixing chamber which provides about its perimeter space for only a small number of additional injection bores, is overcome by the invention.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A mixing head for a reaction injection molding machine, comprising:
a body including a mixing chamber formed with an injection bore;
a charging assembly for introducing at least two reactive components into the mixing chamber;
a feed assembly having at least two feeds for supply of different additional components to the mixing chamber; and
a moveable adapter for selectively and detachably coupling the feeds of the feed assembly to the injection bore for selective introduction of the additional components, said adapter being constructed for rotation in relation to the mixing chamber so that an exit port of each feed is connectable with the injection bore through rotation of the adapter.

2. The mixing head of claim 1, wherein one of the reactive components is polyol and the other one of the reactive components is polyisocyanate

3. The mixing head of claim 1, wherein the adapter has at least a forward zone constructed in the shape of a piston.

4. The mixing head of claim 1, wherein the adapter has a piston-shaped configuration.

5. The mixing head of claim 3, wherein the forward zone of the adapter is defined by a longitudinal axis which extends in a plane perpendicular to an discharge direction of the mixing chamber.

6. The mixing head of claim 5, wherein the longitudinal axis extends parallel but not coaxial to a center axis of the injection bore.

7. The mixing head of claim 3, wherein the forward zone of the adapter has an end surface, said exit ports of the feeds of the feed assembly being provided in the end surface which overlaps the injection bore so that the exit ports are selectively connectable with the injection bore by turning the adapter.

8. The mixing head of claim 3, wherein the feeds of the feed assembly are constructed in the shape of bores in axis-parallel relationship.

9. The mixing head of claim 7, wherein the feed assembly has connections for connecting the feeds to reservoirs for the additional components, said connections being disposed on an adapter side which is distal to the end surface.

10. The mixing head of claim 9, wherein the connections extend at an angle to an axis of the forward zone.

11. The mixing head of claim 3, wherein the forward zone is moveable substantially tangential to the mixing chamber and/or rotatably configured, wherein the injection bore defines essentially a contact point of the tangent.

12. The mixing head of claim 3, wherein the exit ports of the feeds are disposed in a plane perpendicular to an axis of the forward zone.

13. The mixing head of claim 3, wherein the forward zone includes essentially axis-parallel feed bores to the exit ports for the additional components.

14. The mixing head of claim 13, wherein the forward zone of the adapter has inlet bores for the feed bores in one-to-one correspondence in an outer surface area of the forward zone for communication with reservoirs for the additional components through axial movement of the forward zone.

15. The mixing head of claim 14, wherein the inlet bores are disposed offset in axial relationship.

16. The mixing head of claim 14, further comprising a seal assembly for sealing the inlet bores and the exit ports of the feeds from one another.

17. The mixing head of claim 16, wherein the seal assembly includes a groove filled with sealing compound attached about the forward zone.

18. The mixing head of claim 1, further comprising a vacuum apparatus constructed for connection to the adapter for cleaning the injection bore.

19. The mixing head of claim 18, wherein the adapter has at least a forward zone constructed in the shape of a piston, said forward zone being provided at a distance to the exit ports of the feeds with at least one vacuum bore which is connectable with the injection bore and with the vacuum apparatus.

20. The mixing head of claim 1, wherein the charging assembly and the injection bore extend essentially in a same plane perpendicular to a discharge direction of the mixing chamber.

21. The mixing head of claim 1, wherein the feed assembly is provided at the exit port of each feed with a nozzle device for metering the additional component via the injection bore into the mixing chamber.

22. The mixing head of claim 1, wherein the adapter is constructed to allow heating thereof.

23. The mixing head of claim 1, wherein the adapter is constructed for contacting the injection bore under pressure.

24. The mixing head of claim 23, wherein the adapter has hydraulic or electromagnetic means for applying the contact pressure.

25. The mixing head of claim 1, wherein the adapter has electric or hydraulic means for moving the adapter in relation to the mixing chamber.

26. The mixing head of claim 13, wherein the feed bores have different diameter.

27. The mixing head of claim 1, wherein the charging assembly is constructed to introduce the reactive components at a pressure which is lower than a pressure by which the additional components are introduced.

28. The mixing head of claim 27, wherein the reactive components are introduced at 150-200 bar while the additional components are introduced at a pressure of 80-150 bar.

29. The mixing head of claim 9, wherein the reservoirs for the additional components are constructed to include a circulation system having a bypass circuit so that the additional components can be introduced into the feeds or bypass the feeds.
